(19) United States
(12) Patent Application Publication
(10) Pub. No.: US 2006/0166066 A1
(43) Pub. Date: Jul. 27, 2006

(54) Solid-polymer electrolyte fuel cell

(76) Inventors: Katsunori Nishimura, Hitachiota (JP); Jinichi Imahashi, Hitachi (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/336,848

(22) Filed: Jan. 23, 2006

(30) Foreign Application Priority Data
Jan. 24, 2005 (JP) 2005-015215

(51) Int. Cl. H01M 8/10; H01M 8/24; H01M 2/08

(52) U.S. Cl. 429/32; 429/38; 429/35

(57) ABSTRACT

A solid-polymer electrolyte fuel cell comprising power generating units each being constituted by laminating an electrolyte membrane sandwiched between a pair of electrodes, and a pair of gas diffusion layers disposed on the electrodes, wherein laminated portions are formed in the peripheries of the power generating units by laminating a separator, a gasket, the power generating unit, a gasket, and a separator in this order. Covering parts each has a gas flow channel forming groove, a plurality of gas flow channel forming leg portions extend in the direction of the depth of the grooves, and supporting portions for uniting the gas flow channel forming leg portions, the covering parts being inserted into the grooves.

### CLAIM OF PRIORITY

This application claims priority from Japanese application serial No. 2005-15215, filed on Jan. 24, 2005, the content of which is hereby incorporated by reference into this application.

### FIELD OF THE INVENTION

The present invention relates to a solid-polymer electrolyte fuel cell wherein internal leakage is suppressed and degradation in power generation performance is prevented.

### BACKGROUND OF THE INVENTION

Solid-polymer electrolyte fuel cells produce high output, have long lives, are less deteriorated due to start and stop, are low in operating temperature (approximately 70 to 80° C.), and have other like properties. Therefore, they have various advantages, including ease of start and stop. For this reason, there are expected a wide range of applications, such as power sources for electric vehicles and dispersed power sources for commercial use and for home use.

One of these applications is a dispersed power source (e.g., co-generation system) equipped with a polymer electrolyte fuel cell. It is so designed that electricity is taken out of the polymer electrolyte fuel cell and heat generated from the cell when electric power is generated is recovered as hot water. Thus, this system makes effective use of energy. With respect to their duration of service, these dispersed power sources are required to have lives of 50000 to 80000 hours. To meet these requirements, improvements have been made with respect to membrane-electrode assembly, cell configuration, power generation conditions, and the like.

The lives of polymer electrolyte fuel cells are determined by the lives their membrane-electrode assemblies intrinsically have. In addition, the lives of polymer electrolyte fuel cells are governed by voltage drop due to deterioration in electrode catalyst or the like caused by leaks in cells and by other like factors. To prevent the latter deterioration, techniques to enhance the airtightness in cells are required. As techniques related thereto, techniques involving the following seal structure have been publicly known: a connecting portion is covered with a flat plate to form a tunnel portion, which is provided with a flat plate-like seal portion with reinforcements (Patent Documents 1 and 2). In addition, an invention using a structure that enables the following has been also disclosed: channels that guide gas from one side of separators to the other side are provided at some midpoint between a manifold and a generation face; the area in each separator face without channels can be sealed with gaskets (Patent Document 3). Further, there has been known a technique in which a reinforcing member is provided in the connecting portion between a manifold portion and channel grooves (Patent Document 4).

[Patent Document 1] Japanese Unexamined Patent Publication No. Hei 9(1997)-35726

[Patent Document 2] Japanese Unexamined Patent Publication No. 2000-133289

[Patent Document 3] Japanese Translation of Unexamined PCT Application No. 2004-522277

As illustrated in FIG. 1, a polymer electrolyte fuel cell is constructed with a laminated body of a separator, a gas diffusion layer, a membrane-electrode assembly (MEA), and a separator taken as a power generation unit. In the areas in proximity to electrode faces, a laminated structure composed of a separator 104, a gasket 105, an electrolyte membrane 102, a gasket 105, and a separator 104 is formed. A large number of power generation units are laminated with these laminated structure portions in-between. A power collecting body 114 and end plates 107 are added, and the power generation units are pressurized and integrated with bolts 116, nuts 118, and the like. In the separators, there are formed gas channels for distributing fuel gas and oxidizer gas. When the above laminated structure portion is viewed, the following is found: as shown in the top sectional view in FIG. 3, the gaskets 105 are deformed in the direction of gas channels due to clamping pressure P applied to the power generation cells. As a result, sealability is degraded in proximity to the gas channels. FIG. 9 illustrates pressure change at the anode and the cathode observed using a conventional fuel cell stack, which develops the phenomenon illustrated in FIG. 3. Though FIG. 3 is exaggerated, significant pressure change due to deformation in gaskets are observed with time, as apparent from FIG. 9.

In a polymer electrolyte fuel cell, there are grooves that connect manifolds in separator planes and channels in contact with membrane-electrode assemblies. Internal leaks are prone to occur at points where a gasket and an MEA are only partly clamped together because of these grooves and there is a shortage of clamping pressure. In such partly clamped areas, gaskets are deformed by heat produced when electric power is generated, and the gaskets and membrane-electrode assemblies are dissociated from each other. This further increases the internal leakage quantity.

To suppress internal leakage, consequently, areas where gaskets and membrane-electrode assemblies are only partly clamped only have to be eliminated. With techniques in the past, however, it may be impossible to accomplish the above purpose even when separator planes are apparently flat by simply placing a cover plate or the like over protruded portions. Gaskets and membrane-electrode assemblies are so thin parts as dozens to hundreds of micrometer. Therefore, in a case where there is a slight difference in height between a cover plate and a separator, gaps can be produced between the gasket and the like and the separator.

As a result, internal leakage can only become worse depending on the extent of these gaps. Consequently, an object of the present invention is to provide a polymer electrolyte fuel cell wherein the airtightness in the cells is improved and drop in the cell voltage is thereby suppressed, and a power generation system equipped with this fuel cell.

### SUMMARY OF THE INVENTION

According to the present invention, the following is provided: a polymer electrolyte fuel cell having solid polymer electrolyte membranes for separating anode gas and cathode gas, wherein degradation in the sealability in the cells due to deformation in gaskets is improved. More specific description will be given. According to the present invention, a solid-polymer electrolyte fuel cell is provided which is constructed as follows: a solid-polymer electrolyte fuel cell comprising power generating units each being constituted by laminating an electrolyte membrane sandwiched between a pair of electrodes, and a pair of gas diffusion layers disposed on the electrodes,

wherein laminated portions are formed in the peripheries of the power generating units by laminating a separator, a gasket, the power generating unit, a gasket, and a separator in this order, and

wherein covering parts each has a gas flow channel forming groove, a plurality of gas flow channel forming leg portions extend in the direction of the depth of the grooves, and supporting portions for uniting the gas flow channel forming leg portions, the covering parts being inserted into the grooves.

Power generation units are individually constructed by laminating a gas diffusion layer and separators with an electrolyte membrane sandwiched therebetween between a pair of electrodes; a laminated portion is formed in proximity to the electrode faces of such power generation units by laminating a separator, a gasket, an electrolyte membrane, a gasket, and a separator in this order; a covering part includes multiple gas channel forming leg portions extended in the direction of the depth of the gas channel grooves in the separator and a supporting portion that integrates the gas channel forming leg portions; and the polymer electrolyte fuel cell is loaded in the above gas channel grooves with the covering parts.

According to the present invention, internal leakage in a fuel cell can be suppressed and drop in its cell voltage can be prevented; and further a long-life fuel cell can be provided.

According to one aspect of the present invention, there is provided a solid-polymer electrolyte fuel cell comprising power generating units each being constituted by laminating an electrolyte membrane sandwiched between a pair of electrodes, and a pair of gas diffusion layers disposed on the electrodes, wherein laminated portions are formed in the peripheries of the power generating units by laminating a separator, a gasket, the power generating unit, a gasket, and a separator in this order, and wherein covering parts each has a gas flow channel forming groove, a plurality of gas flow channel forming leg portions extend in the direction of the depth of the grooves, and supporting portions for uniting the gas flow channel forming leg portions, the covering parts being inserted into the grooves.

### BRIEF DESCRIPTION OF THE DRAWINGS

FIG. 1 is a schematic diagram of a cell stack using separators of the present invention.

FIG. 2 is a diagram illustrating the configuration of a power generation system equipped with a polymer electrolyte fuel cell of the present invention.

FIG. 3 is a sectional view of a separator of a structure according to the related art.

FIG. 4 is a plan sectional view of Portion B in FIG. 1.

FIG. 5 is a sectional view illustrating the structure of a channel groove in a separator of the present invention.

FIG. 6 is a sectional view of the upper part of a separator, used in the present invention, with a covering part fit in a gas channel groove in the separator.

FIG. 7 is a sectional view of a separator of the present invention taken after a covering part is installed.

FIG. 8 is a graph showing pressure change observed when a pressure difference of 10 kPa is established on the anode side of a cell stack using separators of the present invention.

FIG. 9 is a graph showing pressure change observed when a pressure difference of 10 kPa is established on the anode side of a cell stack using separators of a structure according to the related art.

### DETAILED DESCRIPTION OF THE PREFERRED EMBODIMENTS

The above-mentioned gasket is abutted against the supporting portion of the above-mentioned covering part. For the covering part, it is preferable that a material higher in coefficient of thermal expansion than the separator should be used. Use of such a covering part brings the following advantage: when temperature rise occurs during the operation of the fuel cell, the covering parts are expanded more than the separators. Therefore, the gaskets can be clamped with reliability, and gas leakage can be suppressed.

For the covering part, it is advisable to use a material that is not reduced at the potential of anode when the fuel cell is in open-circuit condition and is not oxidized at the potential of cathode in the same condition.

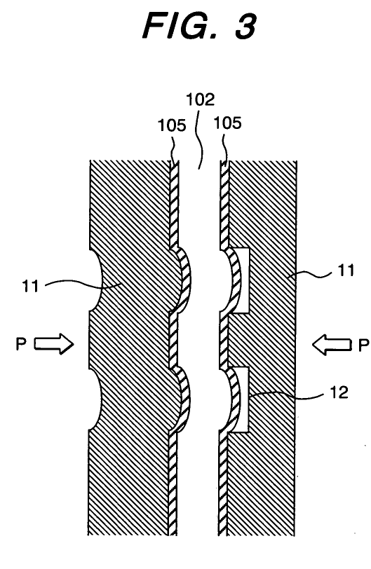

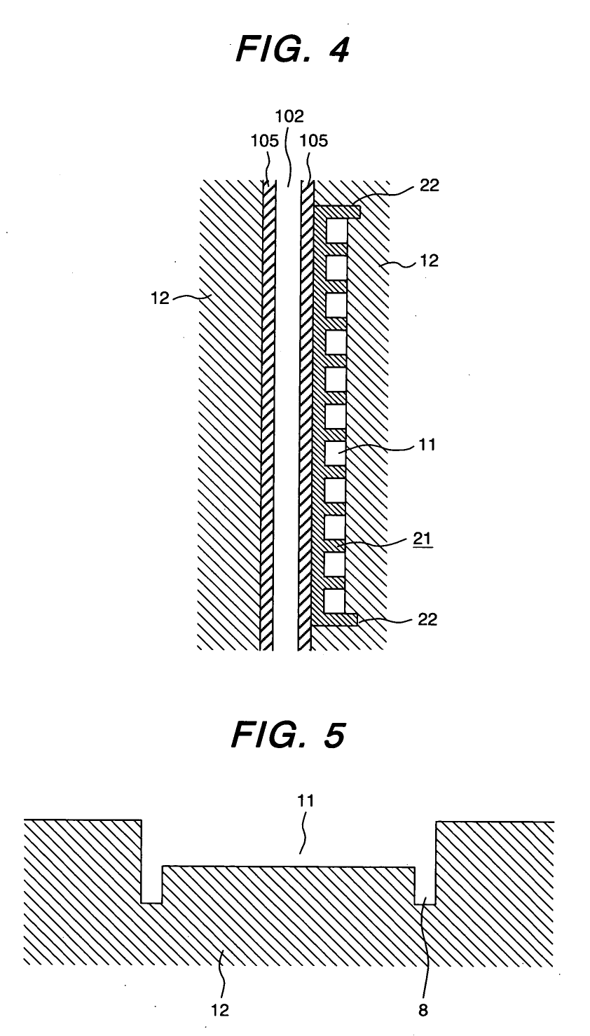

It is preferable that the covering part should have gas channel forming projected portions (leg portions) that are brought into contact with the bottom faces of the gas channel grooves. When the multiple gas channel forming projected portions (leg portions) are brought into contact with the bottom faces of the channel grooves, the following advantages are brought: even when the supporting portion that ties together the leg portions is brought into contact with a gasket, such deformation as illustrated in FIG. 3 is not caused, and the covering part and the gasket can be brought into sufficiently tight contact with each other, as illustrated in FIG. 4.

It is preferable that the face of the supporting portion of the covering part, brought into contact with the gasket, should be smaller in height than the plane of the separator. Adoption of such a construction facilitates the manufacture of the covering part. The difference L in height between the upper face of the supporting portion and the surface of the separator only has to be between dozens of micrometer and hundreds of micrometer.

Further, it is preferable that the covering part should have coming-off preventing projected portions (leg portions) longer than the gas channel forming projected portions. This makes the assembled power generation unit easier to handle. The coming-off preventing projected portions are inserted into deeper grooves formed in the gas channel grooves or in proximity thereto.

According to the present invention, a long-life power generation system and a long-life movable body equipped with the above-mentioned polymer electrolyte fuel cell are provided.

Some of separator channels were provided with steps small but large enough to receive a cover plate by the present inventors. These cover plates were installed on separators, and the degree of improvement in airtightness was evaluated. As the result of evaluation, the following was found: unless the cover plate and the separator were within such a dimensional tolerance that the upper face of the cover plate was substantially flush with the level of the flat face of the separator, the airtightness would not be improved and the internal leakage quantity would vary. This dimensional tolerance is 10 to 20 micrometers or so. It is equivalent to the limit value of the accuracy of part finishing, and is not realistic for the yield of the part.

The present inventors considered relaxing the above strict requirements of dimensional tolerance by utilizing the following: heat produced when the polymer electrolyte fuel cell generates electric power, and a difference in coefficient of thermal expansion between separators and cover plates. More specific description will be given. Steps are provided beforehand between the surfaces of separators and the surfaces of cover plates, allowing for a difference in coefficient of thermal expansion between them. Thus, it is unnecessary to take into account such a dimensional tolerance like the limit of accuracy of finishing as mentioned above. It is rational to set the step L so that the cover plate, higher in coefficient of thermal expansion, is lower than the separator, as illustrated in FIG. 7.

Description will be given to the concept and construction of the present invention. The covering parts used in the present invention are formed of a material higher in coefficient of thermal expansion than the material of the separators. Some of channels in a separator plane are provided with a space for receiving a covering part. The steps are provided in the direction of the thickness of the separator in these spaces. When the step is larger than the covering part, the covering part is not flush with the flat face of the separator. For this reason, pressure becomes less prone to be applied to the gasket that is brought into contact with the upper part of the covering part and the membrane-electrode assembly, and clamping failure is likely to occur.

In a case where a material higher in coefficient of thermal expansion than the material of the separators is used for the covering parts, their temperature rises to so high a value as 60 to 80° C. during electric power generation. Therefore, the covering parts are increased in thickness, and they become flush with or higher than the flat faces of the separators. Thus, pressure is sufficiently applied to the gaskets in contact with the upper parts of the covering parts and the like, and the airtightness is improved. For this reason, the dimensional accuracy required of the covering part receiving spaces on the separators and the covering parts is relaxed.

Coefficient of linear expansion is a physical quantity that indicates the ratio of the length of a material (test specimen) changed when its temperature rises by 1° C. to the overall length of the material. The size of test specimen, temperature, and the like are specified by various standards, such as JIS and ASTM. In case of the present invention, a coefficient of linear expansion determined by whichever method may be used, taking into account ease of working the separators and the covering parts into test specimens. It is preferable that the test temperature should be as close to the operating temperature of the fuel cell as possible. In case of polymer electrolyte fuel cells, usually, the test temperature should be set to a temperature between near ordinary temperature and 150° C. or below. In any case, it is of paramount importance to evaluate the separator and the covering part under the same conditions.

For example, a plate material for the graphite separators of a polymer electrolyte fuel cell is cut into the dimensions of 20 mm×20 mm×2 mm. When these cut pieces are measured as test specimens, their coefficient of linear expansion is usually within the range of 1×10⁻⁶ to 1×10⁻⁵/° C. For the covering parts, a material whose coefficient of linear expansion is higher than the coefficient of linear expansion of the actually used separators is selected.

Examples of the material of the covering part include engineering plastics, such as polyphenylene sulfide (PPS), polysulfone (PSF), polyethersulfone (PES), polyetheretherketon (PEEK), polyimide (PI), polyamide (PA), polyoxymethylene (POM), and polycarbonate (PC). In addition, general-purpose plastics, such as fluororesins including polytetrafluoroethylene (PTFE), polypropylene (PP), and acrylic resins may be used. Instead, the material may be a thermosetting resin, such as phenolic resin, epoxy resin, melamine resin, and alkyd resin. However, the material is not limited to the foregoing, and the coefficient of thermal expansion may be isotropic or anisotropic. In case of a material high in coefficient of thermal expansion in a specific direction, the direction in which the coefficient of thermal expansion is high is matched with the direction of the thickness of the separators. Thus, the dimensional accuracy requirements can be further relaxed.

In a case where the covering parts are formed of resin material, a material whose glass transition temperature (Tg) is higher than the operating temperature of the polymer electrolyte fuel cell should be selected. In a case where this is not done, the covering parts are deformed during electric power generation, and the clamping pressure applied to the gaskets and the like is reduced at the upper parts of the covering parts. This causes degradation in airtightness.

### First Embodiment

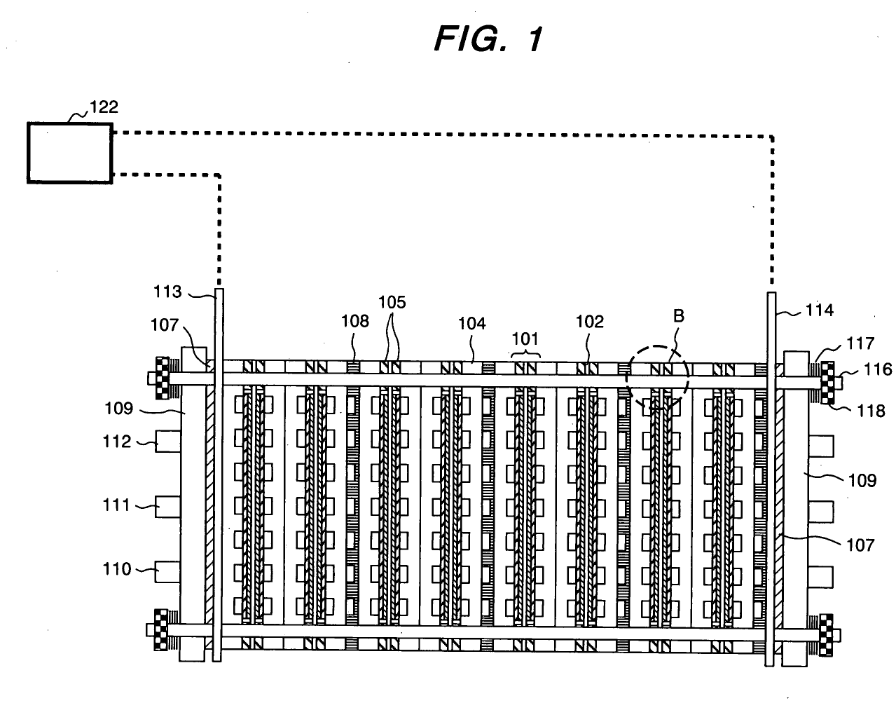

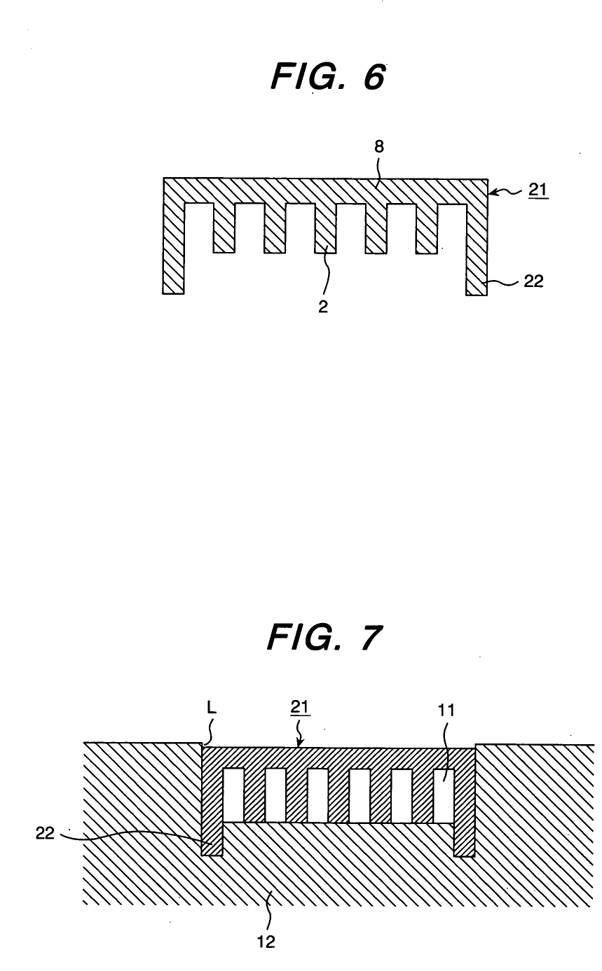

FIG. 5 illustrates the sectional structure of a separator in FIG. 1 as viewed from above. The covering part 21 illustrated in FIG. 6 is inserted into this gas channel groove 11. The covering part includes leg portions 2 that form gas channels and coming-off preventing projected portions (leg portions) 22. The leg portions 2 and the coming-off preventing projected portions 22 are integrated with each other by a supporting portion 8. It is preferable that the leg portions 2 should have such a length that their tips are brought into sufficient contact with the bottom face of the channel groove. FIG. 7 illustrates the covering part as is inserted into the channel groove 11. The upper face of the supporting portion 8 is slightly (L: for example, dozens to hundreds of micrometer) lower than the upper face of the separator. Thus, when the fuel cell operates, the covering part is more expanded and is brought into favorable tight contact with a gasket, and gas leakage can be prevented. The following advantages are brought by providing steps as mentioned above: the dimensional accuracy requirements for the channel grooves in separators and covering parts are relaxed, and they become easier to work.

As illustrated in FIG. 1, multiple single cells 101 including MEA and a gas diffusion layer 106, multiple separators 104 for single cell, and multiple separators 108 for cooling water are laminated. The laminated bodies are clamped, together with collector plates 113 and 114, insulating plates 107, and end plates 109, with bolts 116, disc springs 117, and nuts 118, and they are integrated. On the end plates, connectors 110 for anode gas pipes, connectors 111 for cooling water pipes, and connectors 112 for cathode gas pipes are installed. Generated electric power is transmitted to an inverter 122 and is subjected to power conversion there. The peripheral portions of the single cells 101 are so constructed that an electrolyte membrane is sandwiched between gaskets 105. FIG. 4 illustrates Portion B in FIG. 1.

Some of the channels in the separators 12 were provided with installation spaces 11 for covering part. Then, the covering parts 21 made of PEEK were installed. FIG. 7 illustrates the separator in FIG. 5 with the covering part installed therein. There used to be a possibility that covering parts come off while separators are being transported in a cell stack assembling process. To ensure ease of installing covering parts and further prevent parts from coming off, coming-off preventing projected portions 22 (the left and right terminal portions of the covering part 21) are provided. This brings the following advantages: when the projected portions are inserted into the separator, friction is created by contact between the projected portions and the recessed portions in the separator, and this prevents the covering part from coming off.

As another method for implementing the present invention, the following measure may be taken: the leg portions 2 in FIG. 6 are omitted, and projected portions are formed on the separator 12 and substituted for the leg portions 2. (Refer to FIG. 7.) That is, the leg portions 2 only have to uniformly distribute gas in channels in separator planes. Therefore, whichever, the covering part 21 or the separator 12, is provided therewith, the effect of the present invention is obtained.

The separators of the present invention, the membrane-electrode assemblies, and the gaskets were assembled to form a cell stack. FIG. 1 illustrates the configuration of that cell stack. S1 will be taken for it.

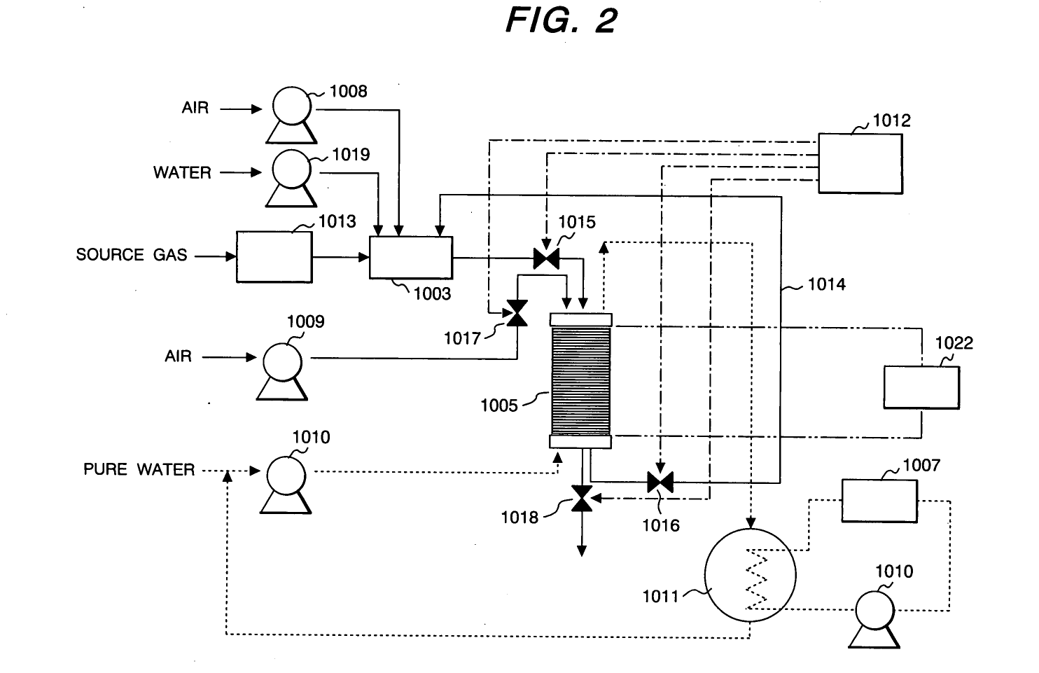

FIG. 2 illustrates the configuration of a power generation system equipped with a polymer electrolyte fuel cell of the present invention. Town gas or the like is supplied as source gas, and is supplied to a reformer 1003 through a pre-filter 1013. Air and water required for producing the reformed gas are supplied through pumps 1008 and 1019. The concentration of hydrogen contained in the reformed gas is set to 70% (dry basis). The anode gas supplied to the stack 1005 is made at the reformer 1003, and is supplied through a supply pipe including an anode gas supply valve 1015.

Cathode gas is supplied to the stack through a pipe including a cathode gas supply valve 1017 by driving a pump (blower) 1009 for air supply. After electric power is generated at the stack, the anode gas is returned to the reformer 1003 through a pipe 1014 including an exhaust valve 1016, and is utilized to keep the heat in reforming catalyst and for other like purposes. The air is emitted to the atmosphere through a pipe including a cathode gas exhaust valve 1018. To remove heat from the stack and recover the heat, pure water is supplied to the stack through a pump 1010.

The power generation system is so constructed that the following operation is performed: water coming out of the stack transfers heat to the water stored in a hot water storage tank 1007 at a heat exchanger 1011, and is circulated to the stack by a pump 1010. The water in the hot water storage tank is circulated by the pump 1010. The present invention is provided with a mechanism that opens and closes the supply valve 1015 for anode gas, exhaust valve 1016, supply valve 1017 for cathode gas, and exhaust valve 1018 through a microcomputer 1012.

A power generation system of the present invention was started, power generation tests were conducted under rated conditions, and the system was operated in stop mode under the same conditions. This starting and stopping operation was repeated 100 times. The test result was as follows: the output voltage of the stack inputted to the inverter 1022 was initially 50V and 59.9V after 100 times of repeat tests under the rated conditions.

FIG. 3 is an enlarged view of the structure of a seal portion according to the present invention. Though not shown in the drawing, a membrane-electrode assembly is provided inside the separator substrate 12 on the right side of the drawing. There are channels 11 for supplying gas to that portion. Above the channels (on the left side of the drawing), the covering part 21 of the present invention is installed. A gasket 105, an electrolyte membrane 102 that forms part of a membrane-electrode assembly, and a gasket 105 are present over the covering part (on the left side of the covering part in the drawing). They are clamped with the separator substrate 12 on the opposite side (at the leftmost end in the drawing). Use of the covering part 21 of the present invention makes it possible to implement the following: in the channels 11 where seal failure is prone to occur, the gaskets 105 and the electrolyte membrane 102 can be clamped between flat parts (the supporting portion 8 and the separators 12); and deflection due to thermal deformation in the gaskets and the like can be prevented. As a result, internal leakage can be suppressed.

Separators wherein the covering illustrated in FIG. 6 was not provided and the projected portions of the channels are flush with the separator faces were prepared and a 10-cell stack was fabricated. For the other parts (gaskets, membrane-electrode assemblies, and the like), the same ones as in the first embodiment were used. The cell stack was fabricated with such a construction that the phenomenon illustrated in FIG. 3 might occur. S2 will be taken for this cell stack.

In the structure of the seal portion of S2 (according to the related art) (illustrated in FIG. 3 in an enlarged manner), a membrane-electrode assembly is provided inside the separator substrate 12 on the right side though it is not shown in the drawing. There are channels 11 for supplying gas to that portion. In S2, the gasket 105, the electrolyte membrane 102 that forms part of the membrane-electrode assembly, and the gasket 105 are placed above these channels (on the left side in the drawing). For this reason, even when they are clamped between the separator substrate and the separator substrate 12 on the opposite side (at the leftmost end in the drawing), the following problem arises: the gaskets and the like are deformed over the channels 11 as illustrated in FIG. 4, and the clamping load becomes insufficient. Deflection due to thermal deformation in the gaskets and the like occurs, and internal leakage becomes prone to occur.

FIG. 9 shows the result of measurement of pressure change at the anode and the cathode, carried out by using S2 and taking the following procedure: nitrogen gas is filled only on the anode side so that a pressure of 10 kPa is obtained relative to the atmospheric pressure; the atmospheric pressure is established on the cathode side, and a pressure difference of 20 kPa is obtained through the membrane-electrode assembly. Nitrogen was supplied only to the anode of this cell stack to increase the pressure to 20 kPa.

The outlet pipes on the cathode side were fully opened at this time. When the pressure of the anode reached 20 kPa, all the pipes and valves of the anode and the cathode were closed. Thus, when nitrogen leaks from the anode to the cathode, the pressure of the anode is decreased and the pressure of the cathode is increased. The result of this experiment is as follows: with the separators according to the related art, the internal leakage quantity was increased, and pressure fluctuation became violent.

### Second Embodiment

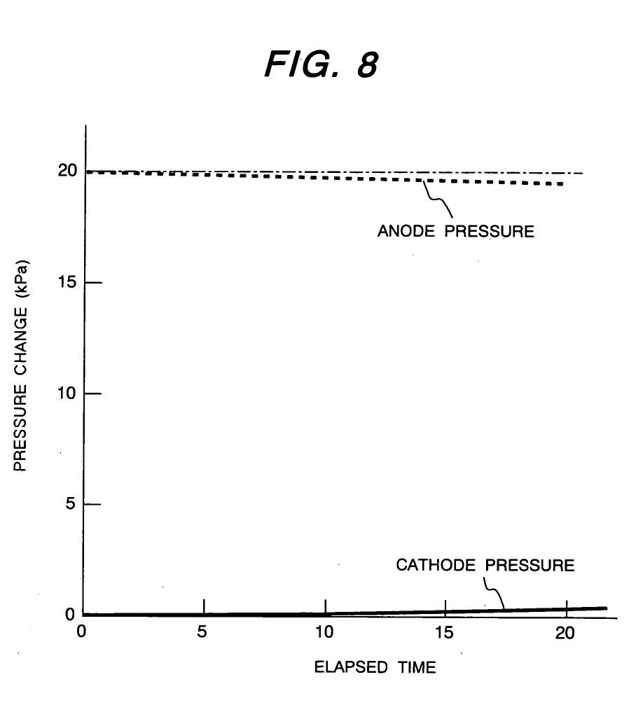

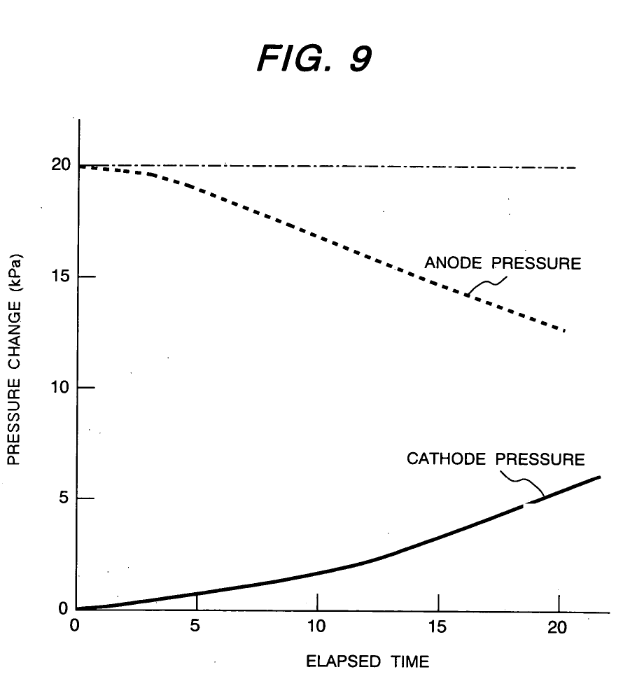

Pressure change at the anode and the cathode of S1 of the present invention was measured under the same airtightness test conditions as used for S2 (FIG. 8). In case of a 20-cell stack S1 using separators of the present invention, the internal leakage quantity was significantly reduced.

Next, continuous power generation tests were conducted on S1 and S2 with hydrogen used as anode gas and air used as cathode gas. The test conditions were set as follows: the current density was 0.2 A/cm²; the fuel utilization factor was 80%; the oxidizer utilization factor was 45%; and the cell stack average temperature was 75° C. As a result, in the cell stack S2 using separators according to the related art, the average voltage drop rate of the cells was 25 mV for 1000 hours. With the cell stack S1 using separators of the present invention, the average voltage drop rate of the cells could be reduced to 5 mV.

What is claimed is:

1. A solid-polymer electrolyte fuel cell comprising power generating units each being constituted by laminating an electrolyte membrane sandwiched between a pair of electrodes, and a pair of gas diffusion layers disposed on the electrodes, wherein laminated portions are formed in the peripheries of the power generating units by laminating a separator, a gasket, the power generating unit, a gasket, and a separator in this order, and
wherein covering parts each has a gas flow channel forming groove, a plurality of gas flow channel forming leg portions extend in the direction of the depth of the grooves, and supporting portions for uniting the gas flow channel forming leg portions, the covering parts being inserted into the grooves.

2. The polymer electrolyte fuel cell according to claim 1,
wherein the gaskets are abutted against the supporting portions of the covering parts.

3. The polymer electrolyte fuel cell according to claim 1,
wherein a coefficient of thermal expansion of the covering parts is larger than that of the separators.

4. The polymer electrolyte fuel cell according to claim 1,
wherein the height of the faces of the supporting portions of the covering parts, in contact with gaskets, is lower than the planes of the separators.

5. The polymer electrolyte fuel cell according to claim 1,
wherein the covering parts are formed of a material that is not reduced at the potential of an anode when the fuel cell is in an open-circuit condition and is not oxidized at the potential of a cathode in the same condition.

6. The polymer electrolyte fuel cell according to claim 1,
wherein the covering parts have the gas channel forming leg portions.

7. The polymer electrolyte fuel cell according to claim 5,
wherein the covering parts further have drop-off preventing leg portions longer than the gas channel forming leg portions.

8. A power generation system equipped with the polymer electrolyte fuel cell according to claim 1.

9. A movable body equipped with the polymer electrolyte fuel cell according to claim 1.
